(19) United States
(12) Patent Application Publication
(10) Pub. No.: US 2008/0189407 A1
(43) Pub. Date: Aug. 7, 2008

(54) Apparatus and Method For User Communication in a Communication System

(75) Inventors: Patricia Mary Charlton, London (GB); Nicolas Lhuillier, Versailles (FR); Jerome Picault, Paris (FR)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/910,589

(22) PCT Filed: Apr. 7, 2006
(86) PCT No.: PCT/US06/12911

§ 371 Date: Oct. 3, 2007

(30) Foreign Application Priority Data
Apr. 8, 2005 (GB) 0507301.0

(51) Int. Cl. G06F 15/173

(52) U.S. Cl. 709/224

(57) ABSTRACT

An apparatus (101) for a data communication system comprises a user group processor (207) which generates a user group for a first user. A set of content topics is determined and stored in a topic set storage (211). A communication processor (201) monitors a data communication of the user group and a content topic processor (205) determines the current content topic of the data communication by content data extraction. A notification processor (209) compares the current topic and the set of content topics and generates a notification signal in response to this comparison. The notification processor (209) may for example alert a user to a change of content topics for a trusted community defined by the user group.

### FIELD OF THE INVENTION

The invention relates to a content topic processing for data communication in a communication system.

### BACKGROUND OF THE INVENTION

Communication systems allowing electronic communication between a plurality of users is becoming increasingly commonplace. For example, electronic text or voice based group communication has become popular.

However, many of the characteristics of conventional direct human communications are not transferred to the electronic domain resulting in a less satisfactory user experience. For example, the selection of conversation topics and the credibility and weight given to received information is in real human communication assessed in response to many other characteristics than the information itself. Such characteristics may for example include the environment in which the communication is received, who is involved in the communication etc.

As a specific example, a human social factor in western society is that the written word and TV medium holds a strong “belief” weight and is more trusted merely because it is written down. Hence textual or visual digital information will have a tendency to be subconsciously believed and this may leave many people vulnerable to exaggerated confidence in the received information.

In addition, electronic communication allows a number of additional techniques and services to be introduced which are not available in normal direct human to human communication. However, current electronic communication systems do not exploit such possibilities but merely provide a simple communication medium through which the communication is exchanged.

Furthermore, in direct human to human communication, the user is exposed to relatively little information due to practical restrictions such as the geographical distribution of users etc. However, in many modern electronic communication systems, such as for example the Internet, users are overwhelmed with data and services provided by different (frequently unknown) sources. This provides a substantial obstacle to the efficient usage of the medium and information.

Thus, data communication provides a number of additional challenges, problems, benefits and opportunities which are currently not fully addressed or exploited by known data communication systems. Hence, an improved data communication system would be advantageous, and in particular a communication system allowing an improved user experience, providing for other characteristics than the communication itself to be taken into account and/or an improved exploitation of the opportunities of data communication.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for a data communication system, the apparatus comprising: group generating means for generating a user group for a first user; means for determining a set of content topics; means for monitoring a data communication of the user group; means for determining a current content topic of the data communication by content data extraction; and notification means for generating a notification signal in response to a comparison between the current topic and the set of content topics.

The invention may allow a content topic monitoring of a data communication based on group characteristics and predetermined set of content topics. This may allow exploitation in a data communication system of group characteristics to provide a notification signal which is indicatory of e.g. a subconscious interpretation which would be applied in a direct human to human communications. An improved user experience may be achieved, not only in comparison to conventional data communication systems, but also in comparison to conventional direct human to human communications. The invention may allow novel functionality in a data communication system. Furthermore, this functionality may introduce characteristics to the data communication system that may compensate for some of the information which is lost to users when communicating in a data communication system rather than in a direct human to human communication.

In particular, the user group may be a trusted community for the first user and the set of content topics may be a set of content topics for which the user group is trusted. Thus, the notification signal may e.g. indicate that the data communication relates to a content topic of high credibility.

The data communication is generally a conversational communication e.g. comprising encoded text or encoded speech. The content topics may represent the conversational context of the communication.

According to an optional feature of the invention, the notification means is arranged to generate the notification signal in response to a comparison between the current topic and a previous topic. This may provide an improved user experience and may allow a highly efficient and context aware content topic change to be notified to e.g. the user.

According to an optional feature of the invention, the notification means is arranged to generate the notification signal in response to detection of a content topic change. This may provide an improved user experience and may allow a highly efficient and context aware content topic change to be notified to e.g. the user.

According to an optional feature of the invention, the group generating means is arranged to generate the user group in response to a user input. The users of the user group may be manually selected by the first user. The feature may provide for an efficient, easy to implement and/or suitable selection of the user group. In particular, it may allow the operation to be targeted to the user's specific preferences and may in particular allow a user to define a trusted community.

According to an optional feature of the invention, the group generating means is arranged to generate the user group in response to a selection from a user list of the first user. The user list may be an address book of the first user. The selection may be automatic in response to a suitable selection criterion, such as all users frequently involved in communication about a specific topic, or may e.g. be manual by a selection based on a user input. The feature may provide for an efficient, easy to implement, facilitated and/or suitable selection of the user group. In particular, it may allow the operation to be targeted to the user's specific preferences.

According to an optional feature of the invention, the apparatus further comprises subset means for determining a subset of preferred content topics of the set of content topics and wherein the notification means is arranged to generate the notification signal if the current topic matches a content of the subset.

The subset may be the same as the set of content topics. The set of content topics may correspond to a list of preferred content topics. The preferred content topics are content topics which are selected in accordance with any suitable selection criterion. The feature may allow a novel service wherein for example a user is notified whenever a trusted community discusses a topic of specific interest to the user.

According to an optional feature of the invention, the subset means is arranged to generate the subset in response to a user selection of content topics of the set of content topics. The preferred topics may for example be explicitly selected in response to a user input e.g. by selection of topics from a list of predetermined content topics.

According to an optional feature of the invention, each content topic of the subset is associated with a first set of attributes, the current content topic is associated with a second set of attributes and the comparison means is arranged to compare the current content topic with each content topic by weighted correlation between the attributes of the first set of attributes and the attributes of the second set of attributes. This provides a particularly advantageous, accurate and/or practical means of performing the comparison.

According to an optional feature of the invention, the notification signal is a user alert signal. The user alert signal may be a suitable signal presented to the user, such as an audio signal or text signal. The invention may provide a novel and advantageous means of alerting the user to data communications of specific relevance in view of the conversational context of the data communication.

According to an optional feature of the invention, the apparatus further comprises means for communicating information associated with the current content topic to the user group in response to the notification signal. The information may for example be presented only to the first user or may be presented to one or more users of the user group. The invention may provide a novel and advantageous means of providing additional information which is targeted and of specific relevance in view of the conversational context of the data communication.

According to an optional feature of the invention, the apparatus further comprises means for updating the set of content topics if the notification means detects no match for the current content topic in the first set. If the comparison indicates that no content topic of the set of content items corresponds to the current content item, the set may be updated. Specifically, the current content topic may be included. The feature may improve flexibility and allow for increasingly improved performance.

According to an optional feature of the invention, the set of content topics is arranged as a hierarchal structure of content topics. The set of content topics may for example be selected by selecting content topics from a template hierarchical structure. The feature may allow improved performance and may allow a more flexible operation and service.

According to an optional feature of the invention, the notification means is arranged to weigh the comparison in response to a hierarchical level of the content topics of the set of content topics. This may improve the accuracy of the comparison with respect to the user's preferences.

According to an optional feature of the invention, the data communication comprises text communication. The data communication may be encoded text data and the content data extraction may be a text content data extraction.

According to an optional feature of the invention, the data communication comprises speech communication. The data communication may be encoded speech data and the content data extraction may be a speech content data extraction. The means for monitoring the data communication may comprise speech recognition functionality.

According to a second aspect of the invention, there is provided a method of user communication in a data communication system comprising: generating a user group for a first user; determining a set of content topics; monitoring a data communication of the user group; determining a current content topic of the data communication by content data extraction; comparing the current content topic and the set of content topics; and generating a notification signal in response to the comparison between the current topic and the set of content topics.

According to an optional feature of the invention, the steps of monitoring the data communication, determining the current content topic and comparing the current content topic and the set of content topics are iterated.

This may provide particularly advantageous performance and may allow a dynamic monitoring of the data communication.

According to an optional feature of the invention, the notification signal is generated if a current content topic differs from a current content topic of the previous iteration.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a communication system in accordance with some embodiments of the invention;

FIG. 2 illustrates a communication terminal in accordance with some embodiments of the invention;

FIG. 3 illustrates a method of operation for a communication terminal in accordance with some embodiments of the invention;

FIG. 4 illustrates a graphic illustration of an example of user tribes or communities; and

FIG. 5 illustrates an example of a hierarchical content topic structure.

### DETAILED DESCRIPTION OF EMBODIMENTS OF THE INVENTION

The following description focuses on embodiments of the invention applicable to group communication using data communication via the Internet. However, it will be appreciated that the invention is not limited to this application but may be applied to many other communication systems.

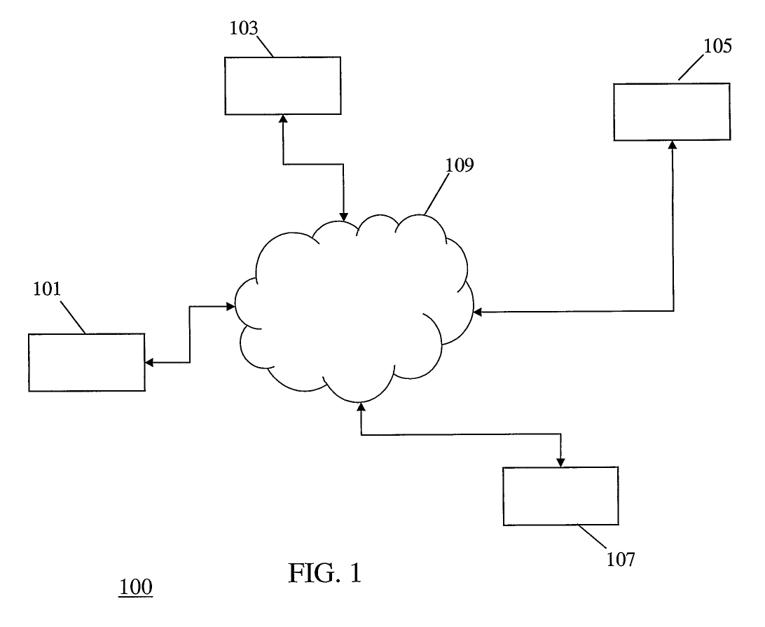

FIG. 1 illustrates an example of a communication system 100 in accordance with some embodiments of the invention.

In the example, a number of users each have a communication terminal 101, 103, 105, 107 for communicating with other users. In the example, each of the communication terminals are connected to the Internet and the group communication is performed by data communication between the communication terminals 101, 103, 105, 107. Specifically, the communication may be a group based voice communication (e.g. using voice over IP techniques) and each communication terminal 101, 103, 105, 107 may comprise a speech encoder that which generates speech data for transmission to all other communication terminals 101, 103, 105, 107 of the group. As another example, the group communication may be a text based communication, such as a chat application. Thus, text may be entered at the communication terminals 101, 103, 105, 107 and the text data may transmitted to the other communication terminals of the group.

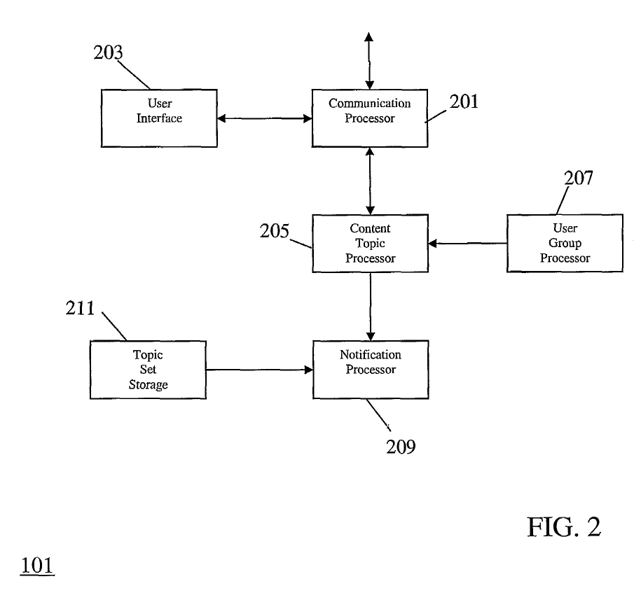

FIG. 2 illustrates a block diagram of a communication terminal in accordance with some embodiments of the invention. The communication terminal may specifically be the communication terminal 101 of FIG. 1 and will be described with reference to this. In the example, the communication terminal 101 is arranged to monitor content topics of the data communication of a selected group of users and to provide a notification signal if a specific content is detected or a content change occurs.

The communication terminal 101 comprises a communication processor 201 which monitors a data communication of the selected user group. The specific user group may for example be selected by the user of the communication terminal by manually selecting users from a locally stored address book.

The communication terminal 101 furthermore comprises a user interface 203 which may present the communication to the user. The user interface 203 may specifically comprise a speech decoder, amplifier and loudspeaker for a speech communication or a text encoder and display for a text communication. The user interface 203 may furthermore comprise input means such as a keyboard or a microphone allowing the communication terminal 101 to transmit data to other communication terminals 103, 105, 107.

The communication processor 201 is coupled to a content topic processor 205. The content topic processor 205 comprises content data extraction functionality which is capable of determining a content topic of the ongoing communication.

The content topic processor 205 is furthermore connected to a user group processor 207 which contains a list of communication terminal identities or user identities for the users belonging to the user group. As previously mentioned, the user group may for example be selected manually by the user. The content topic processor 205 receives information of the user group from the user group processor 207 and uses this information in determining the current content topic. In particular, the content topic processor 205 may filter any communication received such that only communication for the specific user group is taken into account when the content topic is determined.

Thus, the content topic processor 205 will determine the current content topic of the communication of the specific group which is selected by the user. Thus, the content topic is not only interesting to the user because of the content topic itself but also because it is part of the data communication for that specific user group.

The content topic processor 205 is coupled to a notification processor 209. The notification processor 209 is furthermore coupled to the user group processor 207 and to a topic set storage 211. The topic set storage 211 determines a set of content topics which specifically may be topics which are of specific interest to the user. For example, a large number of content topics may be predetermined and the user may manually select a number of these content topics to be included in a set of preferred content topics.

The notification processor 209 compares the current content topic determined by the content topic processor 205 with the set of content topics stored in the topic set storage 211. Specifically, the notification processor 209 may compare the current content topic to the content topics of the set of preferred content topics. If a match is found, the notification processor 209 may generate a notification signal which specifically may be a user alert signal. In this way, the communication terminal may provide a user with a mechanism for identifying if a specific user group, such as a trusted community, performs a group communication related to a content topic of specific interest. Thus, the communication terminal may allow an automated alert that may indicate not only that communication is received which relates to an area of specific interest to the user but also that this group communication is by a specific user group.

Hence, the apparatus may not only provide a service unknown from normal direct human communication but may furthermore take into consideration information which is typically (subconsciously) taken into account in direct human to human conversations. Thus, an improved user experience may be achieved.

As another example, the notification processor 209 may compare the current topic to a previous topic and may detect that a content topic has changed. Thus, if a specific user group exchanges communication related to a content topic in which the user has no interest, the communication terminal may allow an automatic notification to the user when the content topic changes.

It will be appreciated that the functionality of e.g. the content topic processor 205, the notification processor 209 and the topic set storage 211 may in particular be integrated and interrelated. Thus, the content topic processor 205 may directly determine if the current communication has attributes that matches attributes of one of the content topics of the topic set storage 211. If so, the notification processor may determine that a match has been found.

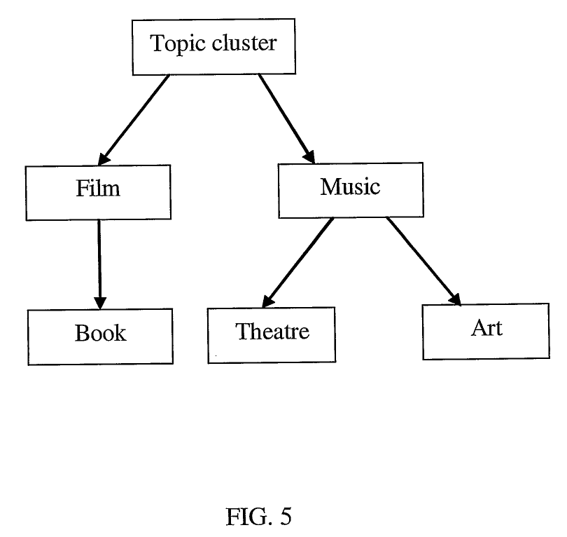

FIG. 3 illustrates a method of operation for a communication terminal in accordance with some embodiments of the invention. The communication terminal may in particular be the communication terminal 101 of FIG. 2 and will be described with reference to this.

The method starts in step 301 wherein the user group processor 207 determines a user group for the user of the communication terminal 101.

Thus, the user defines one or more groups. By doing this, he makes an implicit statement of communication intention and implicit trust with the people in these groups. From a social perspective this indicates these people are of some social value to the user. In the specific example, the user group is determined by the user selecting contacts from an address book application on the communication terminal 101. Although the user group in the described example is determined at initialisation, this does not exclude other groups being created later, or existing groups being modified.

The groups may also be formed automatically by the application based on the interactions of the user with his contacts. For example, the user group processor 207 may determine that specific users are frequently contacted by the user and may therefore be included in the user group.

The step allows a micro-community to be defined manually or automatically. A micro-community (or tribe) is a virtual electronic community that matches to a real group of users who have a common relationship. All the members belonging to such a group are usually known by each other and therefore implicitly trust each other—at least for some topics. Common types of micro-communities are family, close friends, work colleagues, etc. Thus, the user group processor 207 may specifically allow a trusted community to be set up thereby allowing the electronic data communication to reflect social and perhaps subconscious considerations typically only affecting direct human interactions.

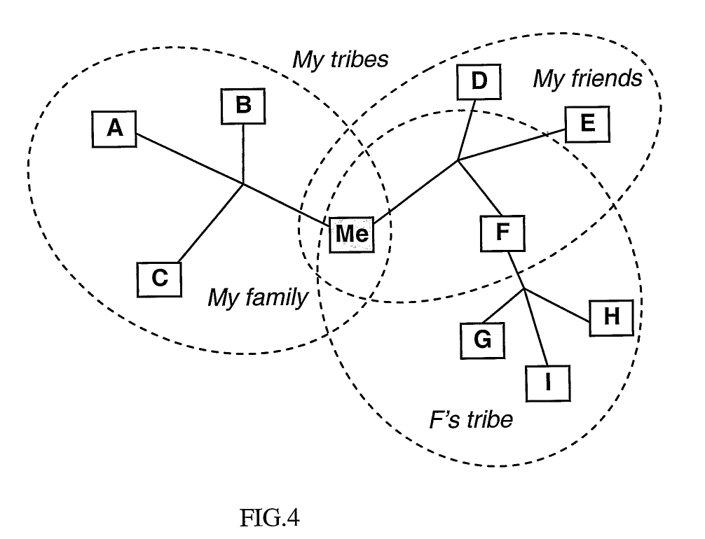

A user may obviously have and be part of several tribes. Thus, more than one user group may simultaneously be defined for the user. The tribe concept is thus relative to an individual: D may be part of my friend's tribe but I may not be part of D's friend's tribe (simply because D may not have a friend's tribe). FIG. 4 illustrates a graphic illustration of an example of user tribes or communities.

Step 301 is followed by step 303 wherein a set of content topics is defined.

In the example, it is assumed that the communication terminal 101 has access to a predefined list of possible content topics for the data communication. It will be appreciated that any means of determining or providing such a list may be used without detracting from the invention. For example domain models defining a list of topics for given applications and communications have been developed for common applications. For example, the Institute of Electrical and Electronic Engineers, IEEE, has developed an ontology standard which defines general models for a number of possible content topics.

In the specific example, the user defines possible conversation topics for his user groups. Specifically, the user may explicitly pick topics from a preset list of content topics from the predefined list and/or may define his own topics. Furthermore, using e.g. the metadata available for the content, topics can also be implicitly learnt from interactions with others. Topics may be a set of interests, e.g. music, books, films, restaurants, theatres, sports/leisure, holidays, photos, videos, birthdays, parent activities, etc. Standard sets of common topics (e.g. entertainment, travel, weather) are already emerging and this will increase in future.

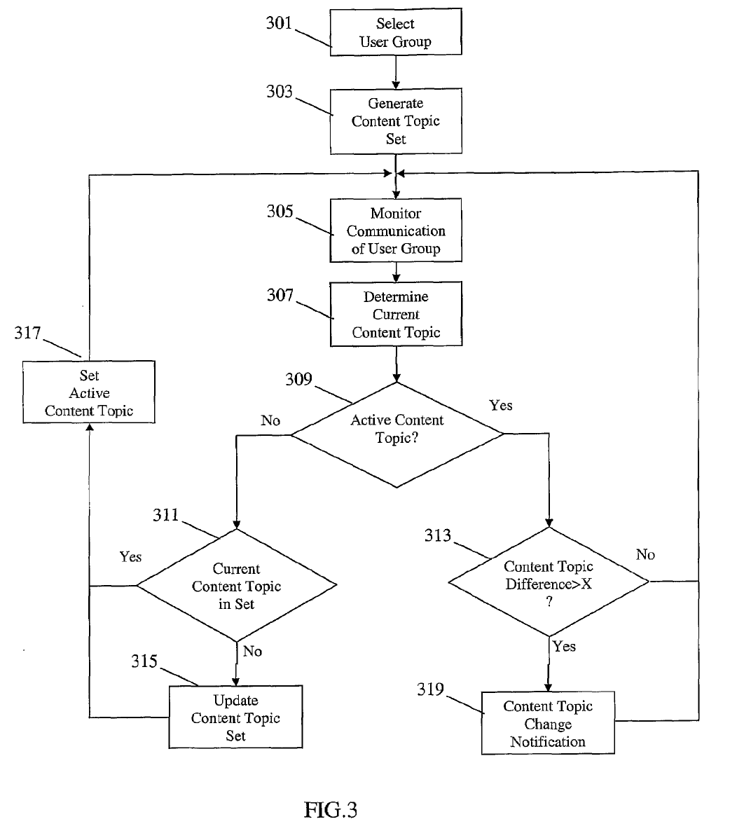

As shown on FIG. 5, topics can be organised into clusters, based on category models such as those found in digital libraries, which can be adapted by the user or learnt over time by the system. There are currently a number of metadata models publicly available and standard modelling languages, such as RDF(S) and OWL, have been developed to create category structures. Typically, use of keywords may form the simplest type of taxonomy structure.

Thus, the content topics in the set may be arranged as a hierarchal structure of content topics. This may allow interrelations between content topics to be taken into consideration. For example, a detection of the “Art” content topic of FIG. 5 may be considered to be a match for the “Music” content item of the hierarchy of FIG. 5.

Step 303 is followed by step 305 wherein the communication processor monitors a data communication of the user group. In particular, the communication processor may pass the data received from any communication terminal associated with the group to the content topic processor 205.

Step 305 is followed by step 307 wherein a current content topic of the data communication is determined by content data extraction.

For example, content topic extraction may be achieved using keyword extraction for text based communication, speech recognition software for voice communication and analysis of metadata associated to content, or using automated content extraction techniques, for images, etc.

As a specific example, topics of text communication may be determined by keyword detection. This may comprise determining a frequency of defined key words and taking into account where a particular key word is located e.g. in the header field of a message, whether it is in bold etc. For example “Which restaurant should we eat at this evening? I would like to try the new French restaurant that has just opened”. Restaurant would be picked up as a key word and topic of conversation. The user could have a simple database, which would have a list of key topics and related terms about “restaurant” would provide other important features to look for in the text to provide further semantic meaning that can be easily used to verify the topic of importance.

It will be appreciated that there are many algorithms and techniques known to the person skilled in the art and that any suitable approach may be used without detracting from the invention.

Step 307 is followed by step 309 wherein the notification processor 209 determines if a currently active content topic is set. The currently active content topic corresponds to a content topic which has been determined at previous iterations. Thus, step 309 evaluates if the communication terminal 101 currently has an indication of the topic currently considered to be associated with the data communication.

If not, the method continues in step 311 and otherwise it continues in step 313.

In step 311 the notification processor 209 determines if the current content topic is in the set of content topics.

In the specific example, the content topics have a number of attributes and the comparison is made by a weighted correlation between the attributes of the current content item and the content items of the set of content items.

More specifically, an example of a standard equivalence metric between two content topics x and y may be determined by:

$$Similarity ( x , y ) = {\sum }_{i} Similarity ( {x}_{i} , {y}_{i} ) * {w}_{i}$$

where xᵢ and yᵢ represent the attributes for the content topics and wᵢ is a weighting of the similarity for each particular attribute. There are various approaches for determining similarity between two attributes. One for instance is to count the attributes that exist in the two structures and to match their values. The similarity can also be done e.g. via a relationship model, a template where the set of common values of a metadata model are captured to determine if an attribute belongs to the same family of attributes, and how it is classed within that family. If there are more formal models, metadata, taxonomies and ontologies, groups and hierarchies may be used to determine closeness of the match by analysing disjoint parts of the models (e.g. the fact that a model differs by 4 disjoint topics may be enough to know that it is not similar).

As mentioned, the content topics may be structured according to a hierarchy that may be taken into account in the comparison. E.g. for the example of FIG. 5, if a user has “Films” in the content topic set, then “Books” may be considered a match.

Thus the notification processor 209 proceeds to match the extracted current content item against the possible content topics for the user group using some form of similarity measure such as e.g. that described above.

The notification processor 209 may for example start by comparing the current content topic with the most frequently used topics of the set.

If no match is found between the current content topic and the set of content topics, the method proceeds in step 315 and otherwise it proceeds in step 317.

In step 315 the set of content topic is updated. For example, the user may be requested to provide additional information to the system. This can be achieved via a number of methods: e.g. creating a new topic, adding new keywords or transient concepts to existing topics or changing weights. Thus, the content topic set may be updated to allow a match between an existing content topic or the current content topic may be included in the set. Step 315 is followed by step 317.

In step 317 the active content topic is set to be the identified content topic. Thus, in step 317 the notification processor 209 defines that the group data communication currently relates to the identified content topic. Step 317 is followed by step 305 and thus the method iterates.

When step 309 is executed the next time, the notification processor 209 determines that an active content topic exists, i.e. the communication terminal 101 operates under the assumption that the content topic is as previously identified. The method accordingly proceeds in step 313.

In step 313 it is determined if the current content topic identified in step 307 differs substantially from the active content topic. If so, it is determined that the content topic has changed and the method continues in step 319. Otherwise, the method returns to step 305.

Thus, after some time, as the communication inside the group evolves, the content topic may change. The notification processor 209 may compare the current content topic to the content set comprising the active content topic and may use suitable measures for determining when a topic differs significantly from another topic.

Over time, the system may thus detect that the communication context is changing by matching the original topic against the current content topic. For example, the same approach as for determining a similarity of content topics may be used. E.g. it may be defined that concept x is significantly different from another concept y if:

$${\sum }_{i} {w}_{i} * similarity ( {x}_{i} , {y}_{i} ) \leq δ$$

where δ is a difference threshold. The threshold value can e.g. be a simple constant, a numeric value function, the known set of some attribute values, a number of attribute value differences, etc.

If the threshold is exceeded, the method continues in step 319 and otherwise it proceeds in step 305.

In the specific example, the threshold is set as a default value, which can be explicitly modified by the user. However, the value of the threshold may evolve over time, and the communication terminal 101 may in particular adapt the threshold in response to the user's reactions to trend changes. E.g. if a detected trend change does not affect the user, the threshold is probably too high.

It will be appreciated that other methods such as Markov chains, Bayesian belief models, blackboard systems, etc., are also valid approaches that may be used to compare the content topics.

In step 319, the notification processor 209 triggers a topic change notification in the form of a notification signal. This signal may be used differently depending on the specific application and embodiment.

For example, an alert signal may be presented to the user indicating that the content topic of the group has changed. As the characteristics used to determine the content topic change may be personalised for each user, the triggering of the alert may be different and customised for each individual user. For example, if the content topic relates to “Football” and then moves to “Basketball”, one user in the group who has a very detailed “Sports” content topic in the content topic list may be notified of the change, whereas one who has a general “Sports” topic will not. This allows a personalised experience within a social communication network.

As another example, the communication terminal 101 may cause additional information which is associated with the current content topic to be communicated to the user group in response to the notification signal. For example, whenever the communication terminal 101 detects that a new content topic has been raised it may instigate the communication of predefined information to the user and/or to other users of the user group. E.g. if the data communication changes to relate to the specific content item of “Dining out”, an advertisement for a specific restaurant may be forwarded.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. An apparatus for a data communication system, the apparatus comprising:
group generating means for generating a user group for a first user;
means for determining a set of content topics;
means for monitoring a data communication of the user group;
means for determining a current content topic of the data communication by content data extraction; and
notification means for generating a notification signal in response to a comparison between the current topic and the set of content topics.

2. The apparatus of claim 1 wherein the notification means is arranged to generate the notification signal in response to a comparison between the current topic and a previous topic.

3. The apparatus of claim 1 wherein the notification means is arranged to generate the notification signal in response to detection of a content topic change.

4. The apparatus of claim 1 wherein the group generating means is arranged to generate the user group in response to a user input.

5. The apparatus of claim 1 wherein the group generating means is arranged to generate the user group in response to a selection from a user list of the first user.

6. The apparatus of claim 1 wherein the apparatus further comprises subset means for determining a subset of wanted content topics of the set of content topics and wherein the notification means is arranged to generate the notification signal if the current topic matches a content of the subset.

7. The apparatus of claim 6 wherein the subset means is arranged to generate the subset in response to a user selection of content topics of the set of content topics.

8. The apparatus of claim 6 wherein each content topic of the subset is associated with a first set of attributes, the current content topic is associated with a second set of attributes and the notification means is arranged to compare the current content topic with each content topic by weighted correlation between the attributes of the first set of attributes and the attributes of the second set of attributes.

9. The apparatus of any previous claim wherein the notification signal is a user alert signal.

10. The apparatus of claim 1 further comprising means for communicating information associated with the current content topic to the user group in response to the notification signal.

11. The apparatus of claim 1 further comprising means for updating the first set of content items if the notification means detects no match for the current content topic in the set of content items.

12. The apparatus of claim 1 wherein the set of content items is arranged as a hierarchal structure of content topics.

13. The apparatus of claim 12 wherein the notification means is arranged to weigh the comparison in response to a hierarchical level of the content topics of the first set.

14. The apparatus of claim 1 wherein the data communication comprises text communication.

15. The apparatus of claim 1 wherein the data communication comprises speech communication.

16. A method of user communication in a data communication system comprising:
generating a user group for a first user;
determining a set of content topics;
monitoring a data communication of the user group;
determining a current content topic of the data communication by content data extraction;
comparing the current content topic and the set of content topics; and
generating a notification signal in response to the comparison between the current topic and the set of content topics.

17. The method of claim 16 wherein the steps of monitoring the data communication, determining the current content topic and comparing the current content topic and the set of content topics are iterated.

18. The method of claim 16 wherein the notification signal is generated if a current content topic differs from a current content topic of the previous iteration.

19. A computer program enabling the carrying out of a method according to claim 16.

20. A record carrier comprising a computer program according to claim 19.
